(19) United States
(12) Patent Application Publication
(10) Pub. No.: US 2025/0245314 A1
(43) Pub. Date: Jul. 31, 2025

(54) METHOD AND SYSTEM FOR PERSONALIZING A SECURE ELEMENT

(71) Applicant: GIESECKE+DEVRIENT MOBILE SECURITY GERMANY GMBH, Munchen (DE)

(72) Inventors: Monika ECKARDT, Mammendorf (DE); Claus JARNIK, Windach (DE)

(21) Appl. No.: 18/854,235

(22) PCT Filed: Apr. 21, 2023
(86) PCT No.: PCT/EP2023/025187

§ 371 Date: Oct. 4, 2024

(30) Foreign Application Priority Data
Apr. 22, 2022 (DE) 10 2022 001 390.8
Apr. 20, 2023 (DE) 10 2023 110 087.4

(51) Int. Cl. G06F 21/45

(52) U.S. Cl. CPC G06F 21/45

(57) ABSTRACT

A method is for computer-aided personalization of a secure element onto which an image is loaded. An operating system of the secure element is integrated into the imageOne or more data sets provided individually for the secure element are written to a special memory area of the secure element. A sequence in which the data sets to be written are personalized is defined with a configuration command in the personalization of the secure element.

The invention relates to a method and a system for computer-aided personalization of a secure element onto which an image is loaded, wherein an operating system of the secure element is integrated into said image.

The secure element is e.g. a subscriber identity module in the form of a Universal Integrated Chip Card (=UICC) for managing authentication data for the use of services of a communication network. In other embodiments, the secure element is an embedded UICC (=eUICC), a chip card, an integrated eUICC (=iUICC), an integrated secure element, an embedded secure element, a secure element, a SIM or a chip card.

During the production of secure elements, i.e., for example, an eUICC, these elements are personalized with individual data. An image is initially loaded onto the secure element. This process is carried out, for example, on the premises of the manufacturer of the secure element. Data which are provided individually for the secure element are then written to a special data area on the secure element. This step can also be carried out, for example, on the premises of the manufacturer of the secure element. The further personalization explained below then follows.

The data provided individually for the secure element can comprise confidential data, such as, for example, keys, trusted root certificates, PINs and the like. Such data are therefore non-public and are accessible to a restricted group of persons only. Furthermore, the individual data can also comprise non-confidential (i.e. public) data, such as e.g. an identification of the secure element, public certificates and the like. Confidential data can be personalized separately from non-confidential data, e.g. during the initial start-up of a secure element after the confidential data have been loaded onto the secure element. This personalization can be performed e.g. on the premises of the manufacturer of the secure element or on the premises of the manufacturer of the terminal device into which the secure element is to be integrated. Confidential individual data are normally personalized using a secure handshake method. This process is normally carried out on the premises of the manufacturer of the terminal device.

During the personalization of both confidential and non-confidential data, objects are assigned or created in the secure element and are then subsequently written with the individual data. The personalization is completed following the writing with the data.

EP 1 622 098 A1 describes a concept of distributed personalization of a security element. The security element is set by a first command to a state in which only a second command is accepted by means of which the secure personalization is enabled. The personalization itself is performed by means of a third command.

EP 2 289 225 B1 discloses a method for personalizing a security element of a mobile terminal device in which a distributed personalization is similarly applied. A method is described in which the manufacture of the security element and the installation of the operating system are carried out at one location, and the personalization of the secure element is carried out at a different, secure location. For this purpose, it is proposed to carry out the final personalization of the security element when the terminal device is used for the first time by a user.

DE 199 39 280 A1 discloses a method for initializing and personalizing a chip card. Data structures which enable a unique assignment of personalization data to individual chip card applications are created in the data memory of the chip card. In a preparatory initialization step, application descriptions and assigned personalization descriptions are created in a memory block of a memory area to be personalized. During the subsequent personalization, personalization data for the applications are transferred to the chip card and are assigned to the applications by means of the personalization descriptions. Apart from the personalization data, no further additional data need to be transferred.

The object of the invention is to further improve flexibility in the personalization of a secure element.

This object is achieved by a method for computer-aided personalization of a secure element according to the features of claim 1, and a system for computer-aided personalization of a secure element according to the features of patent claim 11. Advantageous designs can be found in the dependent claims.

In the method according to the invention for computer-aided personalization of a secure element onto which an image is loaded, wherein an operating system of the secure element is integrated into said image, one or more individual data sets provided for the secure element are written to a special memory area of the secure element. The individual data sets contain card-specific data with which the secure element is personalized under the control of the operating system. The method according to the invention is therefore based on a secure element pre-personalized in a manner known per se onto which an image having an operating system to operate the secure element is loaded. The loading or writing of one or more data sets provided individually for the secure element can similarly be performed in a known manner. A “data set”, which is provided individually for the secure element, is understood to mean information which is provided uniquely for one individual secure element only, such as, for example, keys, certificates and the like. The card-specific data are appropriately provided in the form of a data block or a data set chain. Along with card-specific data, the data set chain can also contain data which, for example, are collectively unique to a specific series of secure elements, e.g. batch global data.

In the method according to the invention, a sequence in which the data sets to be written are personalized is defined with a configuration command in the personalization of the secure element.

The use of such a configuration command enables the step of installing personalization data to be interrupted in a controlled manner and to be continued at a later time. This can be used, for example, to divide production times among different locations. A general production, for example, can be carried out at one location, while further personalizations are implemented on the premises of an end customer. This reduces production times in a factory, e.g. on the premises of the manufacturer of the secure element.

The personalization can similarly be divided into logical sequences, e.g. according to a required logic. The installation of essential information, for example, can thus be separated from the personalization of a boot profile.

A further possibility opened up by the use of a configuration command is to divide the segments of a personalization among different sites according to their confidentiality and security requirements.

A further advantage of the procedure according to the invention is that it enables the performance of only a partial personalization in order to be able to perform updates before the further personalization. Different components outside the secure element, e.g. servers, can also be involved, depending on the personalization step. Such components are also referred to as offcard components. These components can be provided, where appropriate, in different environments which can have certified access, non-certified access or HSM access. Different security mechanisms can be implemented depending on the components outside the secure element that are involved.

According to one appropriate embodiment of the method, the data which are intended to be personalized in one or more of the data sets in a first step are defined by the configuration command. Following the personalization of these data in the first step, the further personalization is then interrupted. The data, for example, which are intended to be personalized in the factory of the user of the secure element can thus be defined. The further personalization can then be carried out at a later time.

According to a further appropriate embodiment, it is provided that one or more interruption points up to which the data set(s) is/are personalized are set by the configuration command. This makes it possible to define the time of an interruption in the personalization process. In other words, the data set up to which the personalization is intended to be carried out and the time when the interruption is intended to take place are defined.

A further appropriate embodiment provides that the continuation of the personalization at a later time is configured by means of the configuration command. According to one embodiment, this can be done through the configuration by the configuration command of a predefined event, on the occurrence of which the personalization is continued. An event of this type can, for example, be a reset or the reaching of a predefined number of resets of the secure element. When this event occurs, the further personalization is then continued. In this connection, it is possible to configure a plurality of implicit personalization steps. Only a part of the data set, for example, is personalized for each event, followed by an interruption. When the next event occurs, the personalization is continued.

In a different embodiment, it is provided that the configuration command is transmitted to the secure element at least one further time, as a result of which the personalization is continued at a later time. This personalization procedure similarly enables further parts of the data set to be personalized in distributed steps. The further, distributed steps can be carried out through the reception of a further explicit configuration command depending on the occurrence of a predefined event.

In this way, the personalization of the data sets can be carried out at different times and at different locations, depending on urgency. Important personalizations can be carried out immediately for the production of terminal devices using the secure elements. Further personalizations can be carried out later, e.g. on the premises of the customer of the terminal device. This distributes the total time of the personalization and, as a result, the production time for the manufacturer of the secure element.

According to a further appropriate embodiment, the configuration command is transmitted to the secure element at least one further time, as a result of which the personalization is continued (following an interruption at a later time). The configuration command can accordingly be transmitted once or multiple times to the secure element. The configuration command can be transmitted to the secure element in encrypted or unencrypted form, depending on the application and security requirements. The encryption and/or transmission can be performed according to procedures known from the prior art.

Events for continuing the personalization can thus be configured with the configuration command. A configuration is possible, for example, in which the personalization is continued following a reset of the secure element with predefined data sets, e.g. data set #2 to #3. The remaining data are then personalized thereafter, with the next reset.

If the personalization is intended to be continued following the explicit reception of a further configuration command, the configuration command is transmitted to the secure element at least one further time. Nevertheless, a trigger command, which is used in the prior art to initialize and start the personalization, is required, as previously, only a single time. As a result, backward compatibility with existing systems continues to be supported, and further-reaching adaptations are not required.

A further appropriate embodiment provides that a firmware update key is personalized in one of the data sets in the first step. A firmware update is then carried out in a second step. This offers the facility to carry out a firmware update before the complete personalization of the secure element. The card-specific or confidential data can contain the firmware update keys which are an essential requirement for a subsequent firmware update.

Since no firmware update is possible without firmware update keys, an update cannot conventionally be carried out until the personalization is completed. This means that code which is executed during the personalization cannot be modified and, at the time of creation, this code must have error-free knowledge of the structure of the subsequently loaded data set. In the prior art, this limits the use of a secure element, since it may not subsequently be possible to extend the data sets. An error during the personalization can similarly not be corrected.

These disadvantages can be eliminated by means of the proposed procedure. Since only the firmware update keys are personalized in the first step, this enables an update of the operating system, including the code, for the personalization immediately thereafter. New features which were not yet known at the original development time can thereby be added or personalized. In addition, errors which can occur during the personalization can be corrected.

Along with the personalization method described above, the invention relates to a system for computer-aided personalization of a secure element onto which an image is loaded, wherein an operating system of the secure element is integrated into said image, and wherein the system is configured to carry out the personalization method according to the invention according to one or more preferred embodiments of this personalization method.

Through the controlled personalization, the invention enables the implementation of different levels of trust. The level of trust of a unit involved in the personalization process can similarly be adapted accordingly outside the secure element (offcard component). This means that different components, such as, for example, production machines, incorporated servers, can be involved, depending on the application. It is therefore possible, for example, to carry out a part of the personalization of the firmware update keys on the premises of the manufacturer, and the next sensitive data at the production sites of a terminal device manufacturer, in the terminal devices of which the secure element is intended to be installed. The data sets to be personalized can similarly be stored in a different manner. Each production site can then decrypt only the area predetermined for it.

The flexibility and extensibility of the personalization process are significantly increased as a result. The personalization process can be divided into a plurality of parts in order to distribute production times and production locations and/or to modify and/or extend the personalization process.

The invention is described in detail below on the basis of exemplary embodiments in the attached figures, wherein:

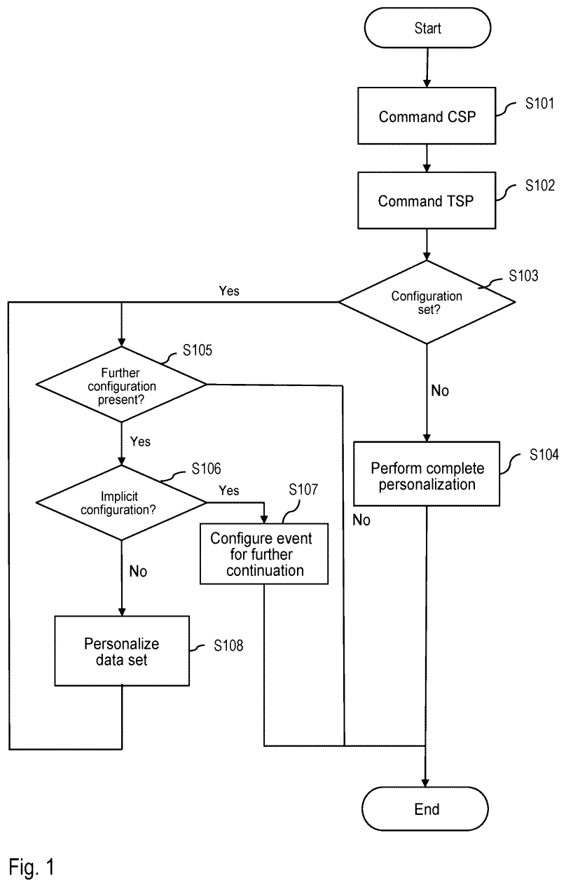

FIG. 1 shows a flow diagram illustrating the configuration of a distributed personalization of a secure element;

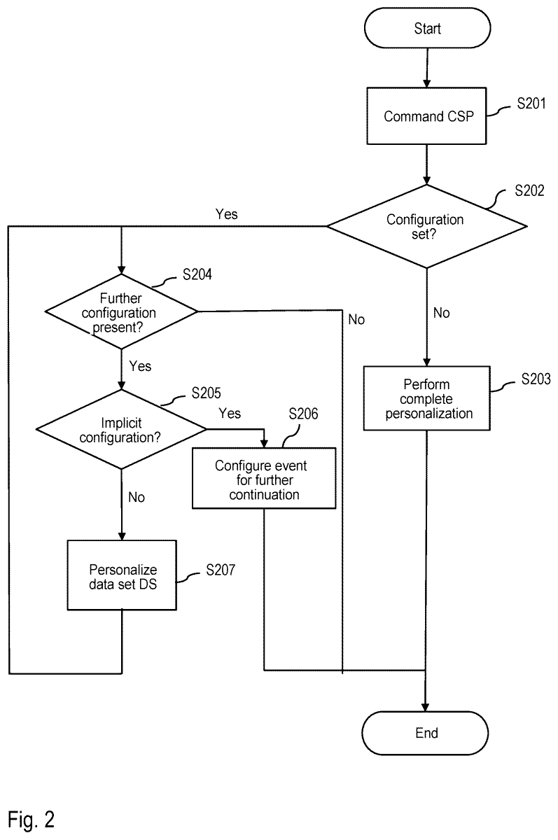

FIG. 2 shows a flow diagram in which an already started personalization is continued by means of an explicitly received configuration command;

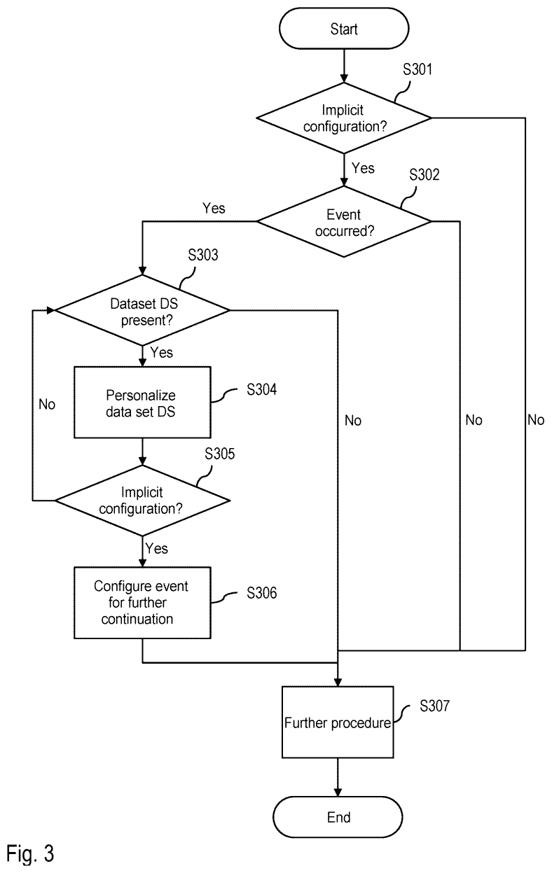

FIG. 3 shows a flow diagram in which an already started personalization is continued when a preconfigured event occurs;

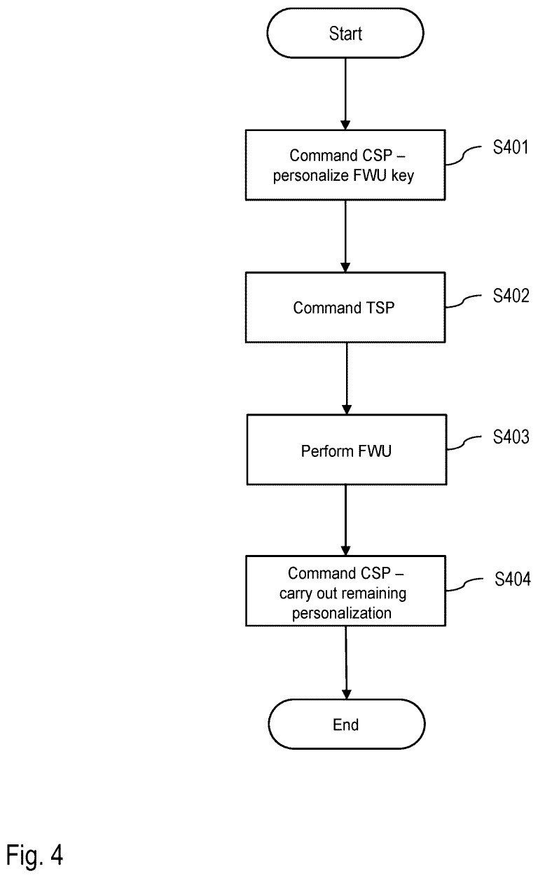

FIG. 4 shows a flow diagram illustrating a distributed personalization of a secure element;

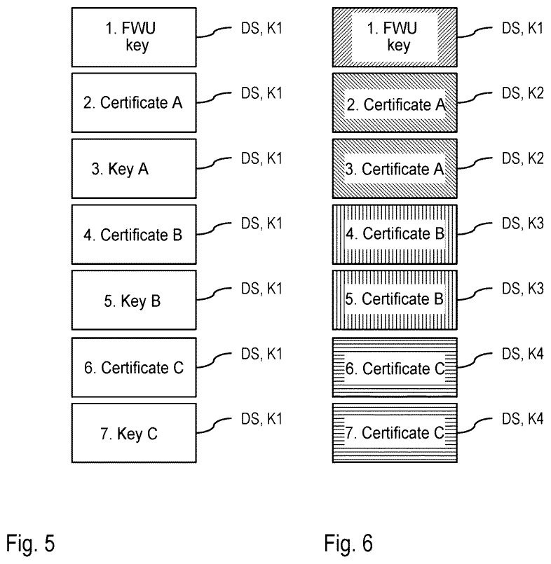

FIG. 5 shows a data set chain having a plurality of data sets to be personalized which are secured with a uniform key; and

FIG. 6 shows a data set chain having a plurality of data sets to be personalized which are secured in various ways according to personalization steps which are to be carried out differently.

The invention is described below on the basis of a secure element which is to be integrated into a terminal device, such as, for example, a cell phone. The secure element is preferably a subscriber identity module permanently installed in the terminal device in the form of an embedded Universal Integrated Chip Card (eUICC) in order to manage authentication data for the use of a mobile radio network. In other embodiments, the secure element can also be a UICC (=Universal Integrated Chip Card), an integrated eUICC (iUICC), a SIM (=Subscriber Identity Module) or a chip card.

The starting point of the method is a secure element (not shown in the figures) on which an operating system is installed. This is typically done by the chip manufacturer of the secure element. The operating system is integrated into an image which additionally contains a root profile.

Once the image is loaded onto the secure element, card-specific data are written to a special memory area of the secure element. These card-specific data can consist of confidential data (such as, for example, keys, trusted root certificates, PINs and the like), and non-confidential data (e.g. card IDs, public certificates). The card-specific data are present as data sets DS (see FIGS. 5 and 6). The card-specific data are appropriately provided in the form of a data block or data set chain, as shown in FIGS. 5 and 6. Along with card-specific data, the data set chain can also contain data which, for example, are collectively specific to a specific series of secure elements. The data block or the card-specific data can similarly be installed, for example, on the premises of the chip manufacturer.

The card-specific data are then personalized, i.e. they are made accessible to the operating system, in each case at the instigation of a configuration command, under the control of the operating system. A key, for example, which is required for a function of the operating system, such as the execution of a firmware update, is written to a location in the memory area at which the operating system expects and requires it.

The card-specific data can have different confidentiality levels. Non-confidential data can essentially be personalized separately from the confidential data, e.g. following the first energization of the secure element and as soon as data have been loaded. This is typically carried out on the premises of the manufacturer of the secure element or in part on the premises of a device manufacturer in whose terminal device the secure element is installed.

Confidential data are typically personalized by means of a secure handshake method using an authentication and a key exchange. The personalization can take place at a later time, e.g. on the premises of the device manufacturer.

Objects are created in the secure element at the time of the personalization according to the card-specific data. The creation of the objects can take up production time depending on the object size, wherein the objects are personalized following the creation with the corresponding card-specific data.

The personalization can therefore be carried out at three different locations:
a) on the premises of the manufacturer of the operating system of the secure element, where the image is loaded into the secure element,
b) on the premises of the chip card manufacturer, where card-specific data are loaded, wherein non-confidential data can optionally be personalized, and
c) on the premises of the device manufacturer, where, if not already done, non-confidential data are personalized and confidential data are finally personalized.

By means of the method according to the invention described below, a sequence in which the data sets DS are personalized can be defined through the use of a configuration command in the personalization of the secure element. The configuration command contains no personalization data, but only configures the performance of the personalization, i.e. the provision of the individual data contained in the data sets DS for the operating system, under the control of the operating system. In particular, it defines how many data sets DS are personalized or in the case of which data set DS a personalization is intended to be interrupted. The configuration command enables a controlled interruption and subsequent continuation of the personalization.

For this purpose, the card-specific data which are used during the personalization are divided into different data sets DS, as shown in FIGS. 5 and 6. All card-specific data for a secure element are appropriately provided collectively in a data set chain together with any series-specific data that are possibly present.

FIG. 5 shows a data set chain which comprises, for example, seven data sets DS. These are all secured with a common or identical key K1. The secure element obtains the key K1 from the personalization device by means of a handshake method. The first data set comprises e.g. an FWU key, the second data set DS a certificate A, the third dataset DS an associated key A, the fourth dataset a certificate B, the fifth dataset DS an associated key B, the sixth data set DS a certificate C, and the seventh dataset DS an associated key C. A, B and C are representative of a production site or a second manufacturer A, B, or C.

FIG. 6 shows the same seven datasets DS of the data set chain, but wherein said data sets are secured with different keys K1 to K4. The key K1, for example, is used to secure the firmware update key. The key K2 is used to secure the second and third data sets. The fourth and fifth data sets are secured with the key K3 and the sixth and seventh data sets are secured with the key K4. The keys K2-K4 are assigned in each case to one of the production sites A, B, C. Each of these production sites can personalize one specific data component, but no more. With this division, it is possible to distribute the personalization among different units and therefore meet different security requirements.

The datasets DS are normally personalized in a defined sequence. The configuration command used according to the invention enables the definition of the datasets DS which are intended to be personalized in a respective step. It is possible to define, for example, that, from the data set chain shown in FIG. 5, only the first data set containing a key for a firmware update is personalized in a first personalization step, and the further personalization is then interrupted. The data, for example, which are intended to be personalized in the production site of the device manufacturer, can thus be defined. The further personalization can then be carried out at a later time.

Since only one key for a firmware update is personalized in the first personalization step, it is thus possible, for example, for an error correction element to be loaded initially into the operating system, said element then enabling the personalization of the further data sets DS in subsequent personalization steps. This essentially also makes it possible to write an entirely new data set chain having new data sets DS to the secure element and subsequently to personalize said data sets.

FIG. 1 shows a flow diagram describing a configuration of the distributed personalization of the secure element (not shown) by means of the configuration command according to the invention. The flow diagram shows how the first configuration is carried out and the personalization is then performed accordingly.

In a first step S101, a command CSP is transmitted to the secure element. The command CSP represents the configuration command. In a step S102, a command TSP is transmitted to the secure element. The command TSP represents a trigger signal known from the prior art which starts the personalization. In step S103, a check is carried out to establish whether a configuration is set. If not (path “No”), a complete personalization is performed in step S104, as known from the prior art, and the personalization then ends.

If a configuration is set in step S103 (path “Yes”), a check is carried out in step S105 to establish whether a further configuration is present. If not (path “No”), the personalization ends. If a further configuration is present in step S105 (path “Yes”), a check is carried out in step S106 to establish whether an implicit configuration is intended to be carried out. This is explained below with reference to FIG. 3. If an implicit configuration is intended to be carried out (path “Yes”), an event is configured in step S107 for the further continuation of the personalization. The method then ends. If no implicit configuration is intended to be carried out (path “No” of step S106), the personalization of the first data set DS of the data set chain still to be performed takes place in step S108 and the method returns to step S105.

Following an interruption of the personalization, the further personalization can be continued by means of the configuration command CSP which is transmitted to the secure element. This personalization is referred to as explicit completion.

FIG. 2 shows a flow diagram illustrating a continuation of the configuration by means of explicit completion. In order to instigate the further personalization, the command CSP, i.e. the configuration command, is transmitted to the secure element in step S201. The trigger command TSP is not retransmitted for the continuation of the configuration. In step S202, a check is carried out to establish whether a configuration is set or present. If not (path “No”), the further personalization is continued in step S203. If a configuration is set in step S202 (path “Yes”), the further procedure corresponds to the procedure described in FIG. 1.

The completion of the personalization can also be performed implicitly. To do this, a special event can be configured in order to continue the personalization. A reset, for example, of the secure element or the determination of a predefined number of resets can be defined for this purpose. The personalization is continued when this event occurs. With this variant, it is also possible to configure a plurality of implicit personalization steps. Only a part of the dataset DS, for example, can be personalized for each event, followed by an interruption. When the next (preconfigured) event occurs, the personalization is then continued.

FIG. 3 shows a flow diagram of the continuation of the personalization following an implicitly occurring event. In step S301, it is determined whether an implicit configuration is present. If not (path “No”), the method continues with step S307 in which the personalization follows a procedure known from the prior art. The personalization and the method then end.

If an implicit configuration is performed in step S301 (path “Yes”), a check is carried out in step S302 to determine whether a predefined event has occurred. If not (path “No”), the method jumps in turn to step S307. If a preconfigured event has occurred in step S302 (path “Yes”), the check to determine whether a dataset DS is present is carried out in step S303. If not (path “No”), the method is continued in turn with step S307. If a dataset DS is present (path “Yes”), the personalization of the data set DS takes place in step S304. In step S305, a check is carried out to determine whether an implicit configuration is present. If not (path “No”), the method returns to step S303 and a check is again carried out to determine whether a data set is present. If the check in step S305 reveals that an implicit configuration is present (path “Yes”), an event is configured for the further continuation. The method then proceeds to step S307.

The described method enables a check to be carried out during the operation of a secure element, e.g. following a reset of the secure element, without a further configuration command, to determine whether an implicit personalization has been configured and is pending. If the configured event has occurred, the personalization is continued. The configured data set is personalized here. A further implicit configuration for further data sets is possible, insofar as this has been configured by the previous configuration command CSP.

Both the implicit completion and the explicit completion of the personalization allow the data sets to be personalized at different times and at different locations, depending on urgency. Personalizations that are important for production can be carried out immediately. Further personalizations can be carried out later on the premises of a customer. This distributes the total time of the personalization and enables production time to be reduced.

The procedure described above can be repeated through multiple transmission of the configuration command CSP (once or multiple times). The command CSP can be transmitted in unsecured or secured form, depending on the application and security information.

An interruption time can thus be defined by means of the configuration command CSP. The data set DS up to which a personalization is intended to be carried out and the time of interruption are defined. Additional implicit events can also be configured in order to continue the personalization. It can be configured, for example, that the personalization is continued after a reset with the data set #2 to #3. The remaining data can then be personalized with a further reset. The sequence in which the data sets DS of a data set chain are personalized is defined in this way by means of the configuration command CSP.

As shown in FIG. 4, a firmware update can be carried out before the complete personalization. According to FIG. 4, the configuration command CSP is transmitted to the secure element in step S401, wherein the configuration is defined such that only the firmware update (FWU) key is personalized. In step S402, the trigger command TSP, which is known from the prior art, is transmitted to the secure element. The personalization of the firmware update keys is then carried out and the personalization process is interrupted thereafter. A firmware update can then be carried out immediately (step S403). A firmware update can contain, for example, an error correction and/or extension. Loaded data sets which were not yet known at the original development time of the secure element can be personalized with the feature extension. Following the firmware update, the configuration command CSP is retransmitted to the secure element in order to initiate the remaining personalization (step S404).

The invention enables firmware updates to be carried out in a targeted and timely manner, i.e. error corrections or feature extensions can be carried out immediately after the personalization of the firmware update keys. A remaining personalization can then be carried out.

The personalization can be distributed among different production sites. Production times can be reduced.

The application or configuration of the personalization can be divided on the basis of different security requirements. If a plurality of production sites with respective security levels are used, the corresponding data sets can be provided with corresponding keys (see the keys K1-K4 in FIG. 6). The personalization of sensitive data can be divided according to the security levels or applications concerned.

The continuation of a started personalization can be controlled explicitly by means of a further configuration command or implicitly by the previous configuration of specific events, e.g. following a specific number of resets.

1.-12. (canceled)

13. A method for computer-aided personalization of a secure element onto which an image is loaded, wherein an operating system of the secure element is integrated into said image,
wherein one or more data sets provided individually for the secure element are written to a special memory area of the secure element, said data sets containing card-specific data with which the secure element is personalized under the control of the operating system,
wherein a sequence in which the data sets are personalized is defined with a configuration command in the personalization of the secure element.

14. The method according to claim 13, wherein the data which are intended to be personalized in one or more of the data sets in a first step are defined by the configuration command.

15. The method according to claim 13, wherein one or more interruption points up to which the data set(s) is/are personalized are set by the configuration command.

16. The method according to claim 13, wherein the continuation of the personalization at a later time is configured by means of the configuration command.

17. The method according to claim 16, wherein a predefined event, on the occurrence of which the personalization is continued, is configured by means of the configuration command.

18. The method according to claim 17, wherein the event is a reset or the reaching of a predefined number of resets of the secure element.

19. The method according to claim 13, wherein the configuration command is transmitted to the secure element at least one further time, as a result of which the personalization is continued at a later time.

20. The method according to claim 13, wherein the configuration command is transmitted to the secure element in encrypted or unencrypted form.

21. The method according to claim 13, wherein a firmware update key is personalized in one of the data sets in the first step.

22. The method according to claim 21, wherein a firmware update is carried out in a second step.

23. A system for computer-aided personalization of a secure element onto which an image is loaded,
wherein an operating system of the secure element is integrated into said image, and
wherein the system is designed such that, during its operation, one or more data sets provided individually for the secure element are written to a special memory area of the secure element, said data sets containing card-specific data with which the secure element is personalized under the control of the operating system, and
a sequence in which the data sets to be written are personalized is defined with a configuration command in the personalization of the secure element.

24. The system according to claim 23, wherein the system is configured to carry out a method for computer-aided personalization of a secure element onto which an image is loaded, wherein an operating system of the secure element is integrated into said image,
wherein one or more data sets provided individually for the secure element are written to a special memory area of the secure element, said data sets containing card-specific data with which the secure element is personalized under the control of the operating system,
wherein a sequence in which the data sets are personalized is defined with a configuration command in the personalization of the secure element.
